(19) United States
(12) Patent Application Publication
(10) Pub. No.: US 2018/0009064 A1
(43) Pub. Date: Jan. 11, 2018

(54) THREE-DIMENSIONAL MODELING DEVICE

(71) Applicant: Seiko Epson Corporation, Tokyo (JP)

(72) Inventor: Takeshi MIYASHITA, Suwa (JP)

(21) Appl. No.: 15/630,140

(22) Filed: Jun. 22, 2017

(30) Foreign Application Priority Data
Jul. 5, 2016 (JP) 2016-132932

(51) Int. Cl. B23K 26/16; B22F 3/105; B23K 26/064; B23K 26/342

(52) U.S. Cl. CPC B23K 26/16; B23K 26/342; B22F 3/1055; B33Y 30/00; B23K 26/064; B22F 2003/1056

(57) ABSTRACT

A three-dimensional modeling device includes a modeling section supplied with a material including a metal powder, a laser source adapted to emit a laser used to sinter or melt the metal powder, and an optical component through which the laser emitted from the laser source passes in the midway to the material on the modeling section. The optical component is provided with a first area, which faces to the modeling section, and through which the laser passes, and a second area higher in surface free energy than the first area is disposed in at least a part of a periphery of the first area.

### BACKGROUND

### 1. Technical Field

The present invention relates to a three-dimensional modeling device.

### 2. Related Art

In the past, there has been known a three-dimensional modeling device which irradiates metal powder with a laser to sinter, or melt and then solidify the metal powder to thereby manufacture a three-dimensional shaped article. In such a three-dimensional modeling device, when the metal powder is sintered or melted, fumes are generated in some cases. The fumes denote fine particles generated by aggregating the metal vapor. If the fumes adhere to an optical component through which the laser passes, the degree of convergence of the laser to the metal powder is deteriorated to thereby degrade the modeling accuracy of the three-dimensional shaped article in some cases. Regarding such a problem, for example, in JP-A-2010-265521 (Document 1), there is disclosed the following technology. That is, in the three-dimensional modeling device, which manufactures a three-dimensional shaped article in a chamber provided with a window through which a laser passes, the capacity of the chamber is changed to thereby help to discharge the fumes in the chamber.

However, in the technology of Document 1, there is a possibility that the mechanism for changing the capacity of the chamber and the mechanism for discharging the fumes from the chamber become complicated. Therefore, in the three-dimensional modeling device, there has been demanded a technology capable of preventing the modeling accuracy of the shaped article from degrading due to the adhesion of the fumes to the optical components with a simple configuration.

### SUMMARY

An advantage of some aspects of the invention is to solve at least a part of the problems described above, and the invention can be implemented as the following configurations.

(1) According to an aspect of the invention, a three-dimensional modeling device is provided. The three-dimensional modeling device includes a modeling section supplied with a material including a metal powder, a laser source adapted to emit a laser used to sinter or melt the metal powder, and an optical component through which the laser emitted from the laser source passes in the midway to the material on the modeling section, wherein the optical component is provided with a first area, which faces to the modeling section, and through which the laser passes, and a second area higher in surface free energy than the first area is disposed in at least a part of a periphery of the first area. According to the three-dimensional modeling device having such a configuration, since the fumes become more apt to adhere to a peripheral area (the second area) of an area (the first area), through which the laser passes, of the optical component than to the first area, it is possible to prevent that the modeling accuracy of the shaped article is degraded due to the adhesion of the fumes to the optical component with a simple configuration.

(2) In the three-dimensional modeling device according to the aspect of the invention, the first area may be provided with liquid repellency. According to such a configuration, the surface free energy of the first area can easily be reduced.

(3) In the three-dimensional modeling device according to the aspect of the invention, the second area may be provided with lyophilicity. According to such a configuration, the surface free energy of the second area can easily be increased.

(4) In the three-dimensional modeling device according to the aspect of the invention, the first area may be provided with a moth-eye structure. According to such a configuration, adhesion of the fumes to the first area can more efficiently be prevented.

(5) In the three-dimensional modeling device according to the aspect of the invention, the three-dimensional modeling device may further include a removing section adapted to remove a particle adhering to the first area. According to such a configuration, adhesion of the fumes to the first area can more efficiently be prevented.

The invention can be implemented in a variety of forms besides the aspects as the three-dimensional modeling device described above. For example, the invention can also be implemented as an aspect such as a method of manufacturing a three-dimensional shaped article using the three-dimensional modeling device.

### BRIEF DESCRIPTION OF THE DRAWINGS

The invention will be described with reference to the accompanying drawings, wherein like numbers reference like elements.

FIG. 1 is an explanatory diagram showing a schematic configuration of a three-dimensional modeling device according to a first embodiment of the invention.

FIG. 2 is an explanatory diagram showing a schematic configuration of a three-dimensional modeling device according to a second embodiment of the invention.

FIG. 3 is an explanatory diagram showing a schematic configuration of a three-dimensional modeling device according to a third embodiment of the invention.

### DESCRIPTION OF EXEMPLARY EMBODIMENTS

### A. First Embodiment

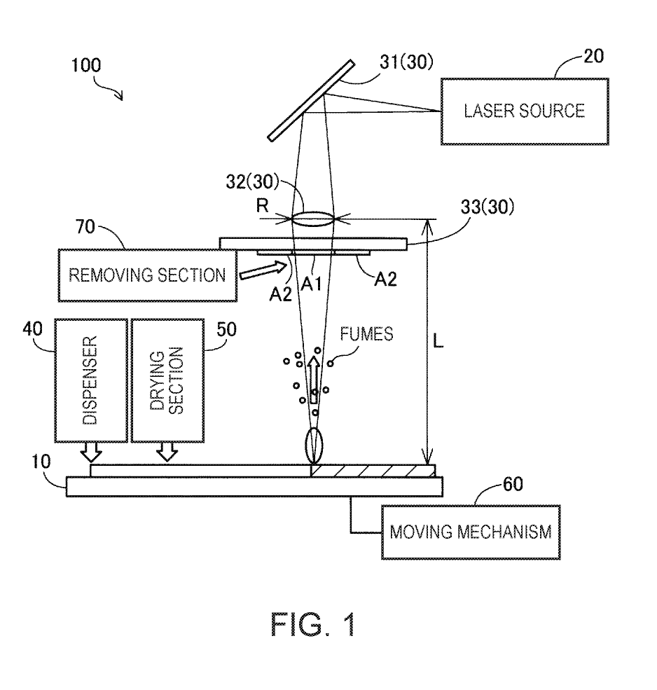

FIG. 1 is an explanatory diagram showing a schematic configuration of a three-dimensional modeling device 100 according to a first embodiment of the invention. The three-dimensional modeling device 100 is provided with a modeling section 10, a laser source 20, and optical components 30. Further, the three-dimensional modeling device 100 according to the present embodiment is provided with a dispenser 40, a drying section 50, a moving mechanism 60, and a removing section 70.

The modeling section 10 is a modeling stage supplied with a material including a metal powder. The upper surface of the modeling section 10 is flat, and the material is supplied on the flat upper surface. The modeling section 10 can be displaced by the moving mechanism 60 in horizontal directions and a vertical direction.

The dispenser 40 is a device for supplying the material on the modeling section 10. In the present embodiment, the dispenser 40 supplies the paste-like material including the metal powder, a solvent, and a binder by ejecting the material toward the modeling section 10 from above the modeling section 10. The supply position of the material to the modeling section 10 is arbitrarily controlled by the moving mechanism 60 moving the modeling section 10.

In the present embodiment, iron is used as the metal powder. Besides iron, for example, aluminum, titanium, copper, magnesium, stainless steel, and maraging steel can be used as the metal powder.

In the present embodiment, N-methyl-2-pyrolidone is used as the solvent. Besides the N-methyl-2-pyrolidone, as the solvent, there can be cited, for example, water, a (poly)alkylene glycol monoalkyl ether group such as ethylene glycol monomethyl ether, ethylene glycol monoethyl ether, propylene glycol monomethyl ether, or propylene glycol monoethyl ether, an ester acetate group such as ethyl acetate, n-propyl acetate, isopropyl acetate, n-butyl acetate, or isobutyl acetate, an aromatic hydrocarbon group such as benzene, toluene, or xylene, a ketone group such as methyl ethyl ketone, acetone, methyl isobutyl ketone, ethyl-n-butyl ketone, diisopropyl ketone, acethylacetone, an alcohol group such as ethanol, propanol, or butanol, a tetraalkylammonium acetate group, a sulfoxide series solvent such as dimethyl sulfoxide, or diethyl sufoxide, a pyridine series solvent such as pyridine, γ-picoline, or 2,6-lutidine, an ionic liquid such as tetraalkylammonium acetate (e.g., tetrabutylammonium acetate), and one species or a combination of two or more species selected from these compounds can be used.

In the present embodiment, as the binder there can be used, for example, acrylic resin, epoxy resin, silicone resin, cellulosic resin, or other synthetic resin, polylactic acid (PLA), polyamide (PA), polyphenylene sulfide (PPS) or other thermoplastic resin.

The drying section 50 is a device for heating the material supplied on the modeling section 10 in advance of the irradiation to the material with the laser to thereby reduce the content of the solvent and the binder in the material. As the drying section 50, there can be used, for example, a lamp heater or a laser. It should be noted that the target temperature of the drying section 50 is lower than the temperature at which the metal powder is melted. Further, it is preferable for the target temperature of the drying section 50 to be equal to or lower than the boiling point of the solvent, or equal to or lower than the decomposition temperature of the binder.

The laser source 20 is a light source for emitting the laser for melting the metal powder. As the laser source 20, there can be used, for example, a fiber laser. When the metal powder is melted by the laser, fumes are generated in some cases. The fumes denote fine particles generated by aggregating the metal vapor. Further, in the present embodiment, since the material includes not only the metal powder, but also the solvent and the binder, a carbide flies from the material due to the irradiation with the laser in some cases.

The optical components 30 are each a component, through which the laser having been emitted from the laser source 20 passes in the midway to the material on the modeling section 10. The optical components 30 guide the laser having been emitted from the laser source 20 to the material on the modeling section 10. In the present embodiment, the optical components 30 include a mirror 31, a lens 32, and a window 33. The mirror 31 reflects the laser having been emitted from the laser source 20 toward the lens 32. The lens 32 is a condenser lens having a predetermined F-value (=(focul distance L)/(lens effective aperture R)), and collects the laser reflected by the mirror 31 to the material on the modeling section 10. The window 33 transmits the laser having been emitted from the lens 32. The optical components 30 can include a plurality of mirrors, and can further include a plurality of lenses in order to guide the laser. Further, the number of the windows is also arbitrary.

In the present embodiment, the window 33 is provided with a first area A1. The first area A1 faces to the modeling section 10, and is an area through which the laser passes. In at least a part of the periphery of the first area A1, there is disposed a second area A2 higher in surface free energy than the first area A1. The expression that “first area A1 faces to the modeling section 10” denotes both of the case in which the first area A1 faces straight to the modeling section 10, and the case in which the first area A1 faces at a certain angle to the modeling section 10, and is not limited to the case in which the optical component 30 and the modeling section 10 are in parallel relationship with each other. Therefore, after all, regardless of the installation angle of the optical component 30 (the window 33), in the case of viewing the window 33 as the optical component 30 from the modeling section 10 side, the first area A1 through which the laser passes is provided to the modeling section 10 side of the optical component 30 (the window 33), and the second area A2 higher in surface free energy than the first area A1 is disposed in at least a part of the periphery of the first area A1.

In the present embodiment, the first area A1 is an area through which the laser passes, and is an area provided with a liquid repellent treatment by being coated with a fluorine-based material such as perfluoroalkylsilane or fluorine-based polymer or silicone. In other words, the first area A1 has liquid repellency. If the first area A1 has liquid repellency, it is possible to easily reduce the surface free energy of the first area A1. Further, in the present embodiment, the second area A2 is an area provided to the window 33 in the entire circumference of the periphery of the first area A1, and is an area provided with a lyophilic treatment by being coated with a titanium oxide material. In other words, the second area A2 has lyophilicity. If the second area A2 has lyophilicity, it is possible to easily increase the surface free energy of the second area A2.

In order to make the fumes and the carbide more apt to adhere to the second area A2 than to the first area A1, it is preferable that the surface free energy of the first area A1 is smaller. For example, the surface free energy of the metal included in the fumes is equal to or higher than 100 mJ/m², and the surface free energy of the fluorine-based coating film is approximately 20 mJ/m². Therefore, it is preferable for the value of the surface free energy of the second area A2 to be more than two orders greater than the value of the surface free energy of the first area A1. More specifically, the surface free energy of the first area A1 is preferably equal to or lower than 50 mJ/m², and more preferably equal to or lower than 30 mJ/m². Further, the surface free energy of the second area A2 is preferably equal to or higher than 1000 mJ/m². As described above, in the present embodiment, the second area A2 is higher in surface free energy than the first area A1. Therefore, it can be said that with respect to the same liquid (e.g., water), the second area A2 is higher in wettability than the first area A1, and the second area A2 is smaller in contact angle than the first area A1.

The removing section 70 is a device for removing the particles having adhered to the first area A1. In the present embodiment, the removing section 70 is formed of a gas injection device for injecting a gas. The gas injected by the removing section 70 is preferably an inert gas such as a nitrogen gas or a argon gas. The removing section 70 constantly injects the gas toward the first area A1 during the shaping period of the shaped article to thereby prevent the fumes and the carbide from adhering to the first area A1. Further, in the case in which the fumes or the carbide have adhered to the first area A1, those are removed by the gas injected by the removing section 70. An amount of the gas injected by the removing section 70 is, for example, 50 through 150 1/min, and is preferably approximately 100 1/min, for example, from a viewpoint of controlling the gas injection power of the removing section 70, and surely removing the particles. Further, in order to prevent the metal particles from dropping before adhering to the second area A2 due to the drop in temperature of the fume, it is preferable for the gas injected by the removing section 70 to be hot air, and to be a gas at 100 through 200° C.

According to the three-dimensional modeling device 100 of the present embodiment described hereinabove, in the window 33, since the second area A2, which is located on the periphery of the first area A1, and through which the laser does not pass, is higher in surface free energy than the first area A1, through which the laser passes, the fumes having flown from the material is more apt to adhere to the second area A2 through which the laser does not pass than to the first area A1 through which the laser passes. This is because, the higher the surface free energy of a solid substance is, the more easily the gas or the fine particles adhere to the solid substance, the more easily the solid substance get wet with a liquid, and the more easily the solid substance adhere to other solid substances, and on the contrary, the lower the surface free energy of the solid substance is, the more stable the interface becomes, and therefore, the harder to bond to the interface the particles flying from the outside become. Therefore, according to the present embodiment, it is possible to prevent that the modeling accuracy of the shaped article is degraded due to the adhesion of the fumes to the optical components with a simple configuration of making the second area A2 higher in surface free energy than the first area A1. In particular, in the present embodiment, since the solvent and the binder are included in the material supplied to the modeling section 10, the carbide becomes apt to fly, besides the fumes. Therefore, according to the present embodiment, it is also possible to prevent not only the fumes but also the carbide from adhering to the first area A1 through which the laser passes.

Further, according to the present embodiment, since the three-dimensional modeling device 100 is provided with the removing section 70, it is possible to make the second area A2 efficiently capture the fumes and the carbide in the unstable state at the interface of the first area A1. Moreover, since in the present embodiment, the surface free energy of the first area A1 of the window 33 is low, it is possible to prevent the fumes and the carbide from adhering to the first area A1 without injecting a large amount of gas from the removing section 70. Therefore, it is possible to miniaturize the removing section 70, and thus, the overall size of the three-dimensional modeling device 100 can be decreased.

### B. Second Embodiment

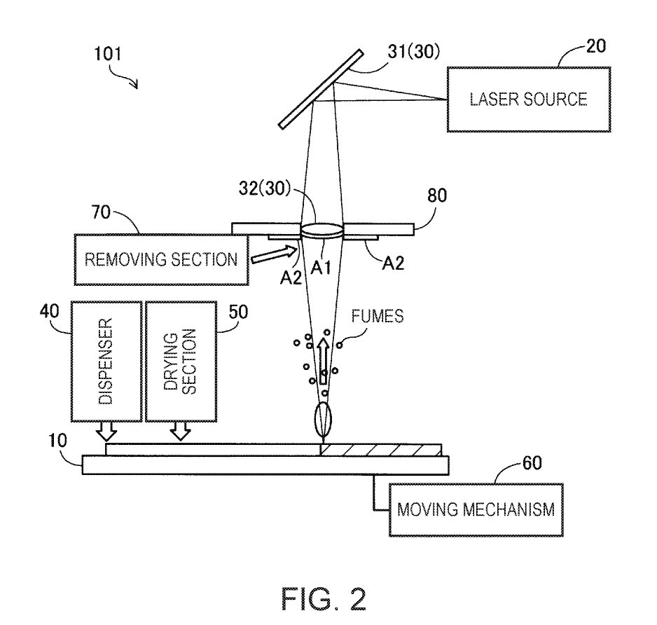

FIG. 2 is an explanatory diagram showing a schematic configuration of a three-dimensional modeling device 101 according to a second embodiment of the invention. The first embodiment described above and the second embodiment are different in the configuration of the optical components 30, and other points are common to the first embodiment and the second embodiment. Therefore, the description of the constituents other than the optical components 30 will hereinafter be omitted.

In the second embodiment, the optical components 30 include the mirror 31 and the lens 32, but do not include the window. In the present embodiment, the lens 32 is fitted in a through hole provided in a central part of a lens holder 80. The lens holder 80 is formed of a material such as resin or metal different from the material (glass) of the lens 32.

In the present embodiment, the lens 32 among the optical components 30 is provided with the first area A1, through which the laser passes, on the surface facing to the modeling section 10. Further, the second area A2 is disposed on the surface, which faces to the modeling section 10, of the lens holder 80. Further, similarly to the first embodiment, the second area A2 is higher in surface free energy than the first area A1.

Also in the second embodiment described hereinabove, since the second area A2, which is located on the periphery of the first area A1, is higher in surface free energy than the first area A1, through which the laser passes, of the lens 32 as the optical component 30, the fumes having flown from the material are more apt to adhere to the second area A2 through which the laser does not pass than to the first area A1 through which the laser passes. Therefore, similarly to the first embodiment, it is possible to prevent that the modeling accuracy of the shaped article is degraded due to the adhesion of the fumes to the optical components 30 with a simple configuration.

### C. Third Embodiment

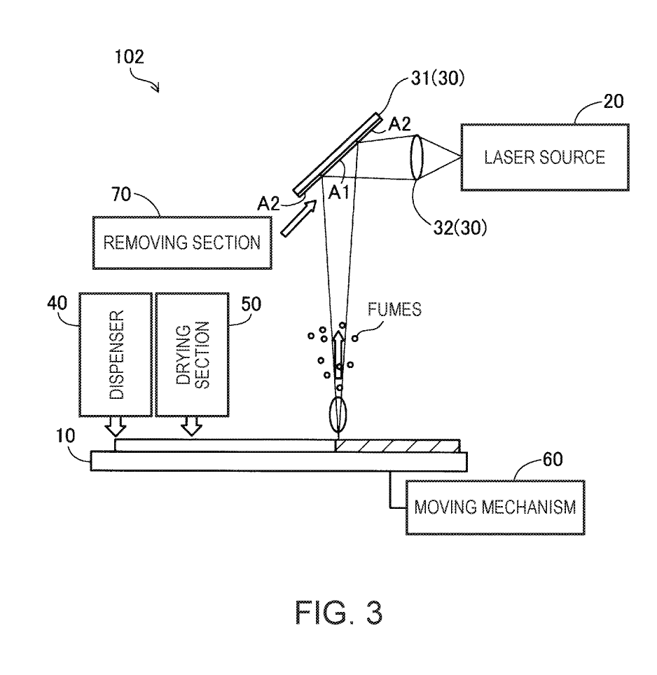

FIG. 3 is an explanatory diagram showing a schematic configuration of a three-dimensional modeling device 103 according to a third embodiment of the invention. The first embodiment described above and the third embodiment are different in the configuration of the optical components 30, and other points are common to the first embodiment and the third embodiment. Therefore, the description of the constituents other than the optical components 30 will hereinafter be omitted.

In the third embodiment, the optical components 30 include the mirror 31 and the lens 32, but do not include the window. In the present embodiment, the lens 32 is disposed between the laser source 20 and the mirror 31.

In the present embodiment, the mirror 31 among the optical components 30 is provided with the first area A1, through which the laser passes, on the surface facing to the modeling section 10. Further, on the periphery of the first area A1 of the mirror 31, there is disposed the second area A2. Further, similarly to the first embodiment, the second area A2 is higher in surface free energy than the first area A1.

Also in the third embodiment described hereinabove, since the second area A2, which is located on the periphery of the first area A1, is higher in surface free energy than the first area A1, through which the laser passes, of the mirror 31 as the optical component 30, the fumes having flown from the material are more apt to adhere to the second area A2 through which the laser does not pass than to the first area A1 through which the laser passes. Therefore, similarly to the first embodiment, it is possible to prevent that the modeling accuracy of the shaped article is degraded due to the adhesion of the fumes to the optical components 30 with a simple configuration.

### D. Other Embodiments

(1) In the embodiments described above, the gas is injected from the removing section 70 to thereby prevent the particles from adhering to the first area A1. However, it is possible to adopt a variety of configurations as the removing section 70. For example, the removing section 70 can also be a vibratory device for applying a vibration to the optical components 30 containing the first area A1, and it is also possible for the vibratory device to apply the vibration to the optical components 30 to thereby prevent the particles from adhering to the first area A1. In order to effectively operate the vibratory sifting effect using the vibratory device, it is advisable to apply the vibrational acceleration more than three times higher than the gravitational acceleration as the centrifugal effect. The centrifugal effect K is expressed as Formula (1) below. It should be noted that r represents a half amplitude, g represents the gravitational acceleration, and N represents the vibration frequency. For example, in order to vibrate the optical components 30 with the half amplitude of approximately 1 μm using the vibratory device, it is sufficient to apply the vibration frequency of approximately 50 kHz.

K(=r(2πN/60)²/g) (1)

(2) It is also possible for the removing section 70 to be a magnetic force generation device for applying magnetic force to the first area A1. For example, when the magnetic force generation device makes magnet operate (e.g., rotate) at high speed in parallel to the first area A1, the electromagnetic induction causes the induced electromotive force in the internal free electrons of the metal particles included in the fumes, and therefore, the metal particles are urged to move in the direction of the current to flow. Therefore, it is possible to make the fumes hard to adhere to the first area A1.

(3) It is also possible for the removing section 70 to be a cleaning device for wiping the first area A1. For example, it is possible for the cleaning device to have a piston reciprocating along the lower surface of the first area A1, reciprocate nonwoven fabric made of ultrafine fiber disposed on the tip of the piston along the surface of the first area A1, to thereby prevent the particles from adhering to the first area A1.

(4) It is also possible for the removing section 70 to include two or more devices out of the gas injection device, the vibratory device, the magnetic force generation device, and the cleaning device described above. Further, it is also possible to eliminate the removing section 70 from the three-dimensional modeling device.

(5) In each of the embodiments described above, it is also possible for the first area A1 to be provided with a moth-eye structure formed of a fine indented pattern. Since the diameters of the metal particles included in the fumes are in a range of 0.1 through several micrometers, it is preferable for the pitch of the projections included in the moth-eye structure to be equal to or smaller than 100 nm, which is equal to or smaller than minimum diameters of the metal particles. If the first area A1 is provided with the fine indented pattern such as the moth-eye structure, the contact area with the metal particles decreases, and it is possible to prevent the metal particles form adhering. Further, due to the reflection suppression effect of the moth-eye structure, it is also possible to suppress the reflection of the laser. It should be noted that it is possible to for the first area A1 to be provided with the moth-eye structure alone, or to be provided with a liquid repellent treatment with a fluorine-based material so as to cover the moth-eye structure. Besides the above, it is also possible to provide the first area A1 with a fractal structure instead of the moth-eye structure.

(6) In each of the embodiments described above, the three-dimensional modeling device can be provided with an ultraviolet irradiation device for irradiating the second area A2 with an ultraviolet beam. If the second area A2 is irradiated with the ultraviolet beam using the ultraviolet irradiation device, due to the photocatalytic effect of the titanium oxide applied to the second area A2, the carbide having adhered to the second area A2 can be decomposed.

(7) The three-dimensional modeling device according to each of the embodiments melts the metal powder to manufacture the three-dimensional shaped article. In contrast, it is possible for the three-dimensional modeling device to sinter the metal powder to manufacture the three-dimensional shaped article. Further, it is also possible for the three-dimensional modeling device to use the metal powder alone as the material. In this case, the dispenser 40 and the drying section 50 can be eliminated from the three-dimensional modeling device, and it is also possible to supply the material to the modeling section 10 by controlling, for example, a hopper or a squeegee.

(8) In each of the embodiments described above, by applying the materials different from each other respectively to the first area A1 and the second area A2, the second area is made higher in surface free energy than the first area. In contrast, it is also possible to use materials different in surface free energy from each other as the base material provided with the first area A1 and the base material provided with the second area A2, respectively, to thereby make the second area higher in surface free energy than the first area.

(9) In each of the embodiments described above, by applying the materials different from each other respectively to both of the first area A1 and the second area A2, the second area is made higher in surface free energy than the first area. In contrast, it is also possible to apply a coating either one of the first area A1 and the second area A2 to thereby make the second area higher in surface free energy than the first area.

(10) In the first embodiment described above, it is also possible for the first area A1 to project toward the modeling section 10 from the second area A2. According to such a structure, it is possible to efficiently make the rising fumes adhere to the second area A2.

The invention is not limited to the embodiments described above, but can be implemented with a variety of configurations within the scope or the spirit of the invention. For example, the technical features in each of the embodiments corresponding to the technical features in the aspects described in SUMMARY section can appropriately be replaced or combined in order to solve all or a part of the problems described above, or in order to achieve all or a part of the advantages. Further, the technical feature can arbitrarily be eliminated unless described in the specification as an essential element.

The entire disclosure of Japanese Patent Application No. 2016-132932, filed Jul. 5, 2016 is expressly incorporated by reference herein.

What is claimed is:

1. A three-dimensional modeling device comprising:
a modeling section supplied with a material including a metal powder;
a laser source adapted to emit a laser used to sinter or melt the metal powder; and
an optical component through which the laser emitted from the laser source passes in the midway to the material on the modeling section,
wherein the optical component is provided with a first area, which faces to the modeling section, and through which the laser passes, and
a second area higher in surface free energy than the first area is disposed in at least a part of a periphery of the first area.

2. The three-dimensional modeling device according to claim 1, wherein
the first area is provided with liquid repellency.

3. The three-dimensional modeling device according to claim 1, wherein
the second area is provided with lyophilicity.

4. The three-dimensional modeling device according to claim 1, wherein
the first area is provided with a moth-eye structure.

5. The three-dimensional modeling device according to claim 1, further comprising:
a removing section adapted to remove a particle adhering to the first area.
